(19) United States
(12) Patent Application Publication
(10) Pub. No.: US 2013/0034740 A1
(43) Pub. Date: Feb. 7, 2013

(54) FUNCTIONALIZED NANO-SILICA FIBER COATING FOR USE AS AN ADHESIVE LAYER FOR INORGANIC FIBERS IN THERMOPLASTIC COMPOSITES

(71) Applicants: Marta M. GIACHINO, Stanford, CA (US); Michael K. Pilliod, San Francisco, CA (US)

(72) Inventors: Marta M. GIACHINO, Stanford, CA (US); Michael K. Pilliod, San Francisco, CA (US)

(73) Assignee: Apple Inc., Cupertino, CA (US)

(21) Appl. No.: 13/229,619

(22) Filed: Sep. 9, 2011

Related U.S. Application Data
(60) Provisional application No. 61/514,428, filed on Aug. 2, 2011.

(51) Int. Cl. B32B 15/04; C09J 167/00; C09J 177/06; C09J 169/00; C09J 155/02; B82Y 30/00

(52) U.S. Cl. 428/457; 525/148; 525/329.3; 525/439; 525/446; 525/464; 525/431; 977/773; 977/902

(57) ABSTRACT

Using nano-particles to topographically enhance the reacting surface of an inorganic fiber used as a reinforcement medium in an embedding matrix is described.

This application claims priority to and the benefit under 35 U.S.C. §119(e) of U.S. Provisional Application Ser. No. 61/514,428, filed Aug. 2, 2011, entitled FUNCTIONALIZED NANO-SILICA FIBER COATING FOR USE AS AN ADHESIVE LAYER FOR INORGANIC FIBERS IN THERMOPLASTIC COMPOSITES by Giachino et. al., the entire disclosure of which is hereby incorporated herein by reference.

### BACKGROUND

1. Field of the Invention

The invention relates to enclosure design for consumer electronic devices and more particularly, methods, apparatus and materials for forming a thermoplastic composite well suited for use with internal and external frame components for electronic devices.

2. Description of the Related Art

In recent years, portable computing devices such as laptops, PDAs, media players, cellular phones, etc., have become small, light and powerful. One factor contributing to the reduction in size of these devices is that from a visual stand point, users often find compact and sleek designs of consumer electronic devices more aesthetically appealing and thus, demand compact and sleek designs. This trend to smaller, lighter and yet durable poses challenges in the design of portable computing devices.

One approach that is used to make smaller, lighter and more compact portable computing devices is to use multi-purpose components. For example, portable computing devices often provide wireless communication along the lines of a cell phone, WiFi, and so on. In order to maintain the compact size desired, wireless communication circuits (such as RF antenna) are integrated into other components. For example, the RF antenna can be formed as part of load bearing elements (e.g., external or then internal portions of the frame). However, in order to utilize a portion of the frame as the RF antenna, RF isolation (i.e., maintaining multiple RF antennae separate from each other) must be provided. By properly isolating multiple RF antennae, that portion of the frame used as an antenna to be properly tuned to receive the frequencies the device needs to operate wirelessly. The RF isolation can be accomplished by utilizing materials with different conductive properties within the frame. From a design point view, it is challenging to find materials that are both strength compatible and can be integrated together in an aesthetically pleasing way.

Thus, in view of above, methods, apparatus and materials are desirable that allow multi-purpose frame components to be designed.

### SUMMARY

Broadly speaking, the embodiments disclosed herein describe methods, apparatus and materials for forming frame components well suited for use in consumer electronic devices, such as laptops, cellphones, netbook computers, portable media players and tablet computers. In particular, materials as well as methods and apparatus for forming device components, such as load-bearing frame components, useable in a light-weight consumer electronic device with a thin and compact enclosure are described. In one embodiment, a topologically enhanced coating can be applied to a ceramic fiber that can, in turn, be mixed with a mold injectable thermoplastic composite well suited for use in portable communication devices. The topologically enhancing coating can take the form of functionally activated nano-silica particles. In one embodiment, the nano-silica particles are functionally activated using amine groups. The thermo-plastic composite can be used to join a number of metal components together to form a load bearing structure where the material provides 1) RF isolation between the metal components, 2) is strength compatible with the metal components and 3) is aesthetically compatible with the metal components.

In one aspect, a material mixture including a ceramic fiber and thermoplastic is described. The ceramic fiber can be coated with silica nano-particles activated with amine groups substantially improving the bond between the ceramic fiber and the thermoplastic matrix. In a particular embodiment, the ceramic fibers and the thermoplastic can be used to form a relatively non-conductive polymer with a tensile module of about 20 GPa or greater. In particular, the ceramic fibers can have a density between 2.5 g/cc-7 g/cc. Further, the tensile modulus of the ceramic fiber filaments can be between about 100 GPa-450 GP. The ceramic fibers can be selected to be relatively non-conductive. For instance, the dielectric constant of the ceramic fibers can be between about 4-35. In one embodiment, the ceramic fibers can be formed from a metal oxide, such as alumina. In one embodiment, the ceramic fibers can be less than 35 volume percent of the material mixture. The material mixture properties, such as the strength and over-all conductance, can be varied by changing the percent volume loading of the ceramic fibers used in the material mixture. In particular embodiments, the fiber loading in the mixture can be selected to meet a desired material mixture performance.

Various thermoplastics can be combined with the ceramic fibers. A few examples include but are not limited to a polymer matrix, nylon, polycarbonate (PC), Polybutylene terephthalate (PBT), PBT/PC blends, Acrylonitrile Butadiene Styrene (ABS) and PC/ABS blends. In a particular embodiment, a material including ceramic fibers, glass fibers and a thermoplastic can be also used.

In another embodiment, a structural component for an electronic device is described. The structural component includes at least a first metal component and a second metal component, and an interface component between the first metal component and the second metal component that joins the first metal component and the second metal component together. In the described embodiment, the interface component is formed of composite material formed of a thermoplastic material, a non-conductive ceramic fiber filler material. The filaments of the ceramic fiber filler material are formed of a ceramic fiber, and a plurality of nano-particles bonded to a surface of the ceramic fiber, wherein most of the plurality of nano-particles are each associated with a plurality of reactive sites, the reactive sites being chemically and mechanically arranged to bond with the thermoplastic material.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 is a perspective drawing of an external frame component in accordance with the described embodiments.

FIG. 2 graphically represents coating of a ceramic fiber with a plurality of functionalized silica nano-particles in accordance with the described embodiments.

FIG. 3 shows a flowchart of a process for providing a functionalized ceramic fiber in accordance with the described embodiments.

FIG. 4 graphically illustrates a specific implementation of the process for functionalizing a ceramic fiber surface in accordance with a specific embodiment of the invention.

FIG. 5 shows a graph detailing a range of amine density on fiber surface for various agents.

FIG. 6 shows a specific implementation of the process described in FIG. 3.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

It is well known that increasing the bonding interfacial surface area benefits the adhesion strength between two materials. Therefore, an optimal way for increasing this interfacial surface area would be by increasing surface roughness. Generally speaking with regards to polymers, increasing surface roughness is a common toughening mechanism for aiding in bonding between a polymer and a substrate. Therefore by coating an inorganic fiber with either functionalized or non-functionalized silica nano-particles in the range of 1 to 2000 nm, the surface area surface area on the fiber to which the matrix can bond substantially increases, effectively transferring the load from the matrix to the fiber system. This improved bonding results in improved mechanical properties of the overall composite including, but not limited to, tensile strength, elongation at break and Young's modulus.

Accordingly, the embodiments within describe using nano-particles to topographically enhance the reacting surface of an inorganic fiber used as a reinforcement medium in an embedding matrix. Each of the nano-particles provides a plurality of reactive sites each site being associated with an amine group. The reactive sites can each in turn bond with the embedding matrix forming in the process a reinforced embedding matrix that can be used to enhance the structural integrity of a frame used for a portable communication device. In one embodiment, the embedding matrix can take the form of a thermoplastic composite that is RF transparent and capable of being injection molded and the fibers can the form of inorganic ceramic fibers. By being both RF transparent and injection moldable, the thermoplastic composite can be used to enhance the structural integrity of a small form factor electronic device with wireless capabilities, such as an iPhone™ manufactured by Apple Inc. of Cupertino, Calif. Since the thermoplastic composite is also RF transparent, the coated fiber enhanced thermoplastic composite can be used to support RF components, such as an RF antenna without unduly affecting either the efficiency or transmission characteristics of the wireless device.

In a specific implementation, a surface of the inorganic ceramic fibers can be functionalized with hydroxyl groups. Once functionalized with the hydroxyl groups, a coupling agent (such as, for example, any silane with a reactive end group) can be grafted to the functionalized surface of the inorganic ceramic fiber. In order to increase the ability of the inorganic ceramic fibers to interact with and bond with the thermoplastic composite, amine functionalized silica nano-particles (having diameters ranging from about 1 nanometer to 2000 nanometers) can be deposited onto the functionalized surface of the inorganic ceramic fiber. The amine functionalized nano-particles covalently bond to the inorganic ceramic fiber providing essentially a topographically enhanced reaction interface in the form of a rough and amine-functionalized surface having a substantially increased surface density of reactive end groups. The increased density of reactive end groups results in improved chemical and mechanical bonding between the inorganic ceramic fibers and the thermoplastic composite.

It should be noted that in prior art applications, this general technology has been used to form superhydrophobic surfaces, such as bio-applications and self-cleaning fabric technology that involved the formation of a planar reaction interface by the addition of terminal end-groups to the silica particles that prevented bonding to most surfaces. Replacing the terminal end-groups with reactive end-groups provides a non-planar reactive surface that allows for improved chemical and mechanical bonding of the inorganic ceramic fibers to the thermoplastic composite. The improved chemical and mechanical bonding can result in improved mechanical properties of the overall composite such as, for example, an increase in tensile strength, elongation at break and Young's modulus.

Device frames can be formed using metal portions joined using a non-conductive thermoplastic material. The metal portions can be used to form separate antennas for a portable electronic device where the non-conductive thermoplastic material provides RF isolation between the metal portions. The metal portions can be joined in an injection molding process where the thermoplastic material is injected into a joint between the two metal portions. The device frame, including the metal portion joined by the thermoplastic material, can be a load bearing structure. Thus, to prevent breakage at the metal joints where the thermoplastic material is used, the strength capabilities of the metal components and the joining thermoplastic material need to be somewhat matched. Most thermoplastic materials by themselves have limited strength capabilities. However, the strength materials of a thermoplastic material can be improved by adding a filler material.

In the example described above, two metal components are joined using a thermoplastic and filler material, such as nylon and glass fibers. A disadvantage of using glass fibers is that a large fill volume of glass fibers can be needed to form a joint of sufficient strength. As the fill volume of the glass fibers increases, the density and hence the weight of the composite material increases. Further, even with a high fill volume of glass fibers, a relatively large joint component formed from the composite material can be required to match the strength properties of the surrounding metal. The size of the joint component between the metal components can affect the metal interface that holds the joint component in place. Typically, as the size of the joint component increases, the size of a metal interface associated with holding the joint component in place also increases. Larger components affect both the weight and packaging design associated with a device.

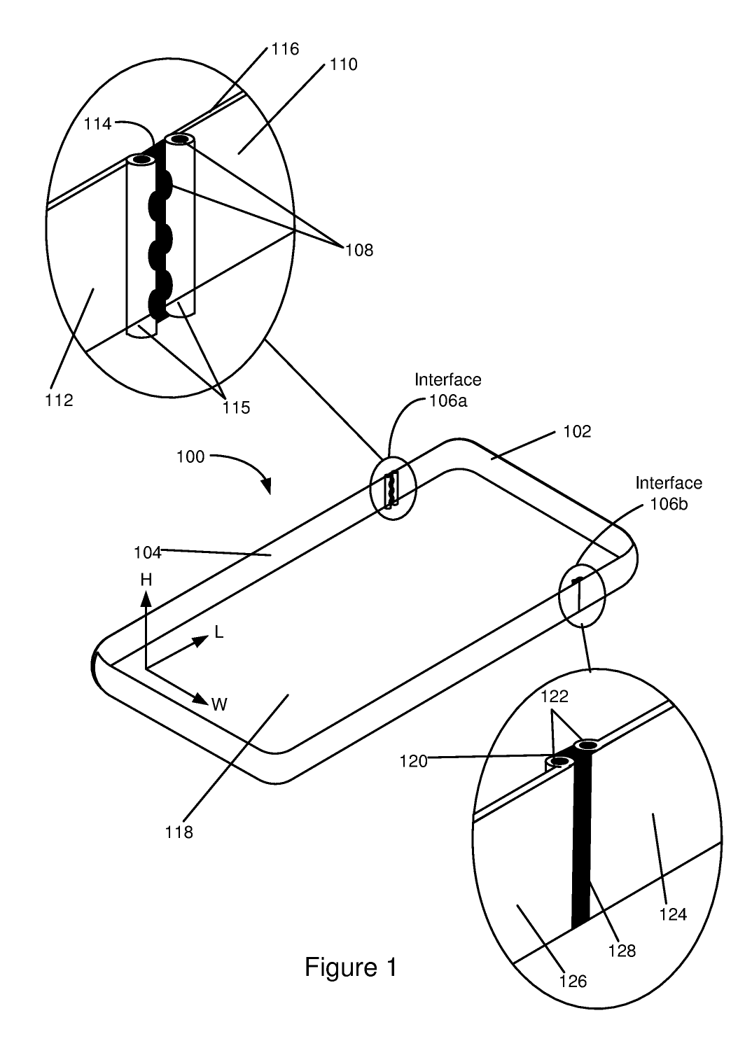

Therefore, the following discussion provides a description of a material mixture including a thermoplastic matrix and a ceramic fiber filler described with respect to FIG. 1. The use of the material mixture to form a joint between two metal components as part of a frame is also described with respect to FIG. 1.

In particular embodiments, composite materials can be formed from a thermoplastic mixed with a fiber fill material, such as a ceramic fiber material. Examples of a thermoplastic that can be used in the material mixture include but are not limited to a polymer matrix, nylon, polycarbonate (PC), Polybutylene terephthalate (PBT), PBT/PC blends, Acrylonitrile Butadiene Styrene (ABS) and PC/ABS blends. One example of a filler material that can be utilized is a ceramic fiber. When the ceramic fiber is used to provide RF isolation and minimize RF loss a material that is relatively non-conductive can be utilized. If RF isolation is not needed, then it may be possible to use a more conductive fiber, such as a carbon fiber. Property ranges of a non-conductive ceramic fiber that can be used as a filler material are described in the following table.

TABLE 1
Ceramic Fiber Properties

| | |
|---|---|
| Density (g/cc) | 2.5-7 |
| Tensile Modulus (GPa) | 100-450 |
| Dielectric Constant | 4-35 |

In various embodiments, the ceramic fibers can be a non-conductive metal oxide, such as an oxide including aluminum, titanium or zirconium. In a particular embodiment, the ceramic fibers can be alumina fibers. In another embodiment, the ceramic fibers can be a titanium oxide, such as titanium dioxide. In yet other embodiments, the ceramic fibers can be formed metal oxides including titanium and aluminum or can be a mixture of alumina fibers and titanium oxide fibers. Other compositions of ceramic fibers are also possible, such a mixture including zirconium, alumina and titanium metal oxides. The ceramic fibers can be coated to increase bonding between the fibers and the thermoplastic. As an example, continuous strands of the ceramic fibers can be coated and then the fibers can be chopped and mixed with a thermoplastic. The fiber lengths can be between 200-500 microns. In some embodiments, fiber lengths can be up to 1000 microns. Fiber diameters can be on the order of about 10 microns.

In one embodiment, pigments can be also be added to the mixture of ceramic fibers and the thermoplastic. The pigments can be used to provide materials of different colors. For instance, pigments can be added to produce a material that is white, black or some color in between. When used in an externally visible component, the use of pigments may allow or more aesthetically pleasing component to be produced.

One advantage of using a thermoplastic with a ceramic fiber filler, such as nylon and alumina, over a thermoplastic with glass fibers, such as nylon and glass, is that a lower volume percent of filler material can be used to achieve a similar strength. For instance, 10 volume percent of alumina fibers in nylon can produce a material that is equivalent in strength to about 30 volume percent of glass fibers in nylon. The lower filler volume can produce a material that is comparatively lighter.

Another advantage is a stronger material can be produced. For instance, a material with a 30 volume percent of alumina fibers in nylon can have a modulus that is about 4 times greater than a material with a 30 volume percent of glass fibers in nylon. A larger modulus may allow less material to be used for an equivalent part. For instance, if the nylon/alumina mixture has a strength modulus greater than a nylon/glass mixture, then a joint between two metal components formed using the nylon/alumina mixture can be smaller than a joint between two metal components formed using nylon/glass mixture. A smaller joint may provide benefits such as a lighter weight and a better packing efficiency.

With respect to the following figures, the method and apparatus for forming device components using thermoplastic and ceramic fiber material mixtures are described. The examples are provided for the purposes of illustration and are not meant to be limiting.

FIG. 1 is a perspective drawing of an external frame component 100. The external frame component can include two frame parts, 102 and 104. The two portions, 102 and 104, can be joined via interfaces 106a and 106b. The external frame components, 102 and 104, surround area 118. Additional frame parts can be placed in area 118. For instance, in one embodiment, a metal tray can be welded into area 118. In a particular embodiment, a thermoplastic/ceramic fiber material, such as nylon/alumina described above, can be used in the joint interfaces 106a and 106b to join the two frame parts, 102 and 104. The two frame parts, 102 and 104, can be composed of a material. Such as a metal. If the two frame parts are used as part of a wireless antenna, then the thermoplastic/ceramic fiber material can be constructed to be relatively non-conductive so that RF losses between the two frame components are minimized. If RF losses are not important, it might be possible to use a more conductive ceramic fiber, such as a carbon fiber with the thermoplastic in the joint interfaces.

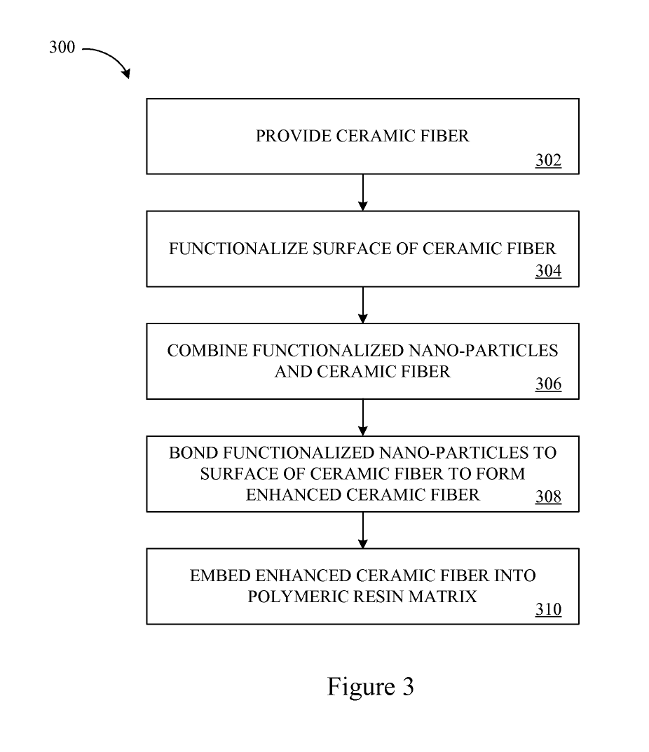

As an example of forming the joint interfaces 106a and 106b, using injection molding, the thermoplastic/ceramic fiber mixture can be injected at location 128 between the external face 126 of part 104 and face 124 of part 102 at joint interface 106b to form part 120 (Injection molding is described in more detail with respect to FIG. 3A). A similar method can be applied at interface 106a to form part 114. As is described with respect to joint 106a, at the joint interfaces, structures, such as 115, can be provided on the internal surface 112 of part 104 and an internal surface 110 of part 102. The structures, such as 115, can be formed from the same or a different material as parts 102 and 104. A structure 122, similar to structure 115, is provided on the inner surfaces of parts 102 and 104 at joint interface 106b.

The structures, such as 115 and 122, at the joint interfaces 106a and 106b can include hollow portions. When the thermoplastic/ceramic fiber mixture is injected into the joint interfaces, the material mixture can permeate into the hollow portions, such as 108. The mixture can then harden to form parts 114 and 122 that hold the parts 102 and 104 together.

Excess material can be deposited during the injection molding process. For instance, excess material can be deposited on surfaces, such as 126 and 124 on the external surface of joint interface 106b. As another example, excess material can be deposited on internal surface, such as onto the structures 115 and the possibly the surrounding surfaces 110 and 112. Also, excess material can be extruded above and/or below the joint interface. If desired, for aesthetic or packaging purposes, excess material can be removed from external, internal, top and/or bottom surfaces surrounding the joint interfaces in a post injection molding finishing step.

As is described above, a nylon/alumina fiber mixture can be stronger than a nylon/glass fiber mixture. The use of a stronger material can affect the design of the joint interfaces 106a and 106b. For instance, when a stronger material is used relative to a less strong material, it may be possible to reduce the size of the interface structures, 114 and 120, as well as the support structures, 115 and 122. Reducing the size of these structures can reduce the weight of the device and improve the packaging design. With respect to FIG. 1, the use of a thermoplastic/ceramic fiber material was described in relation to forming a frame component usable in an electronic device where the thermoplastic/ceramic fiber material is used to form a joints that hold parts of the frame components together.

In alternate embodiment, the ceramic fibers, such as alumina fibers, described herein can be formed into continuous strands. If desired, the continuous strands can be woven together as a mat with a particular width and thickness.

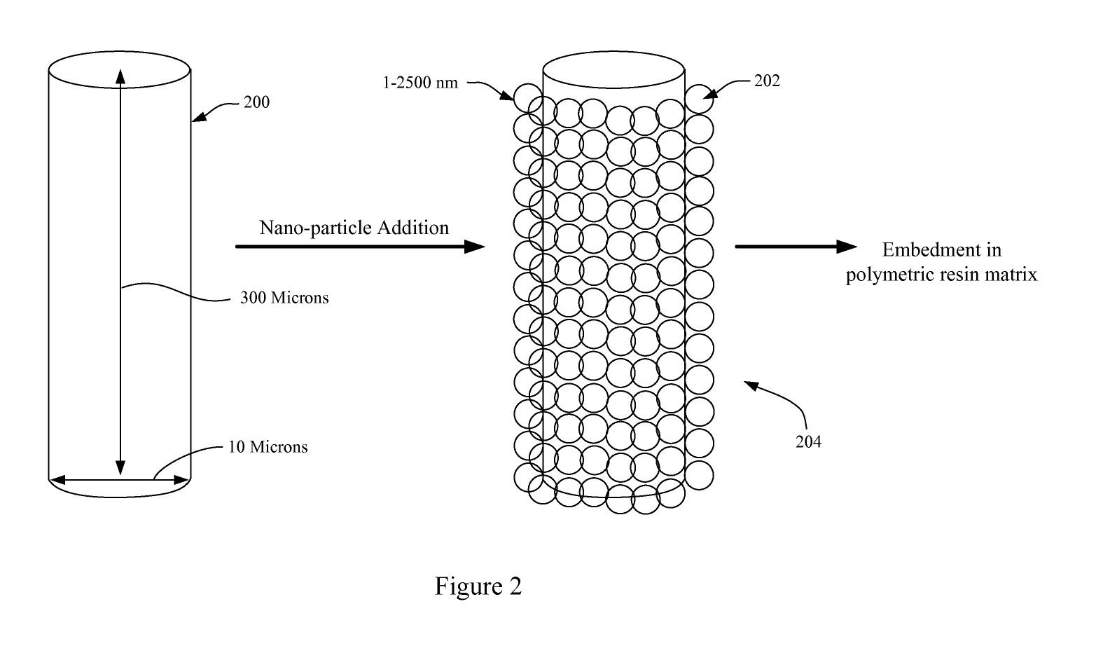

FIG. 2 graphically represents coating of ceramic fiber 200 with a plurality of functionalized silica nano-particles 202 in accordance with the described embodiments. In the described embodiment, nano-particles 202 can be formed of many materials. For example, for the remainder of this discussion, nano-particles 202 are described as being formed in silicon but can, of course, be formed of any appropriate material.

In the described embodiment, ceramic fiber 200 can have a length of about 300 nm and a diameter of about 10 microns whereas nano-particles 202 can have diameters that range from about 1 nm to about 2500 nm. It should be noted that the size of nano-particles 202 can be directly related to the roughness of the reactive surface created on ceramic fiber 200. For example, as the diameter of nano-particle 202 decreases, the number of nano-particles that are able to fit on the surface of fiber 202 increases as does the density of reactive sites. Therefore, enhanced fiber 204 is formed when nano-particles 202 are bonded to the surface of fiber 200. The increase in density of reactive sites on enhanced fiber 204 provides greater bonding, both chemical and mechanical, between enhanced fiber 204 and a polymeric resin in which enhanced fiber 204 is embedded.

FIG. 3 shows a flowchart of process 300 for providing a functionalized ceramic fiber in accordance with the described embodiments. Process 300 can be carried out by providing a ceramic fiber at 302. As discussed above, the ceramic fibers can be a non-conductive metal oxide, such as an oxide including aluminum, titanium or zirconium. At 304, the fiber surface is functionalized. In a specific embodiment, the surface of the ceramic fiber can be hydrolyzed by applying silanol to the ceramic fiber surface that results in hydroxyl groups being added to the ceramic fiber surface. Once the surface of the ceramic fiber is hydrolyzed, a di-functional organic coupling agent can be used to bond an organic compound to the hydroxyl groups to form a hydrophilic ceramic fiber surface. In a specific implementation, the di-functional coupling agent can take the form of 3-Glycidoxypropyltrimethoxylsilane (GPS) or 3-cyanopropyltrichorosilane (CPS).

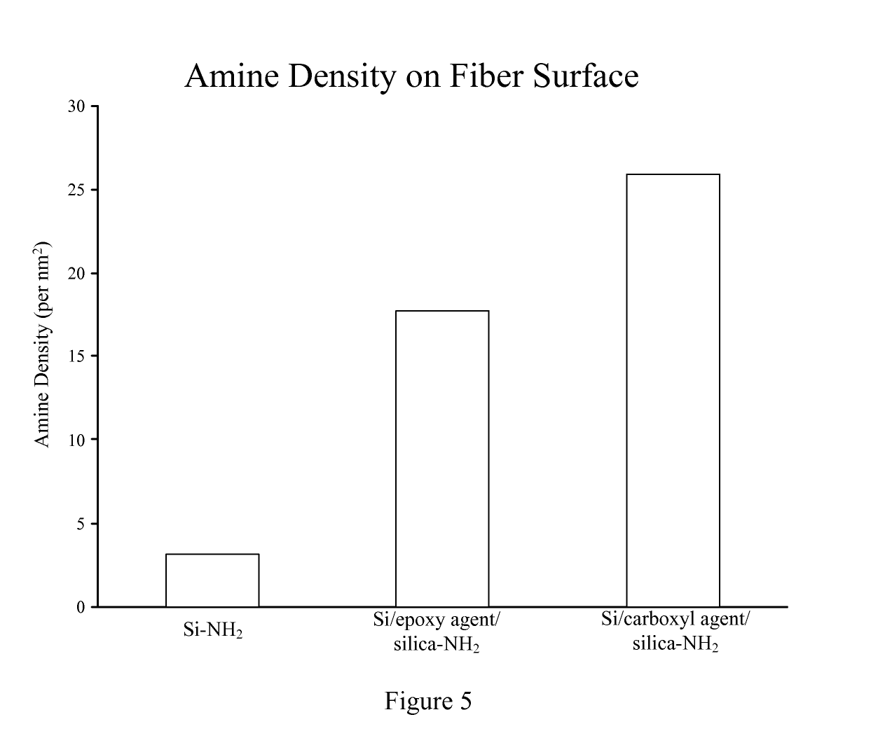

At 306, functionalized nano-particles are added to the ceramic fiber surface. In the described embodiment, the functionalized nano-particles can take the form of amino, epoxy, or carboxyl functionalized silica nano-particles. At 308, most of the functionalized nano-particles bond to the hydrophilic ceramic fiber surface to form a topologically enhanced reactive surface on the ceramic fiber. The topologically enhanced ceramic fiber is then embedded in a polymeric resin matrix at 310. For example, in a particular embodiment, if the functionalized nano-particle takes the form of an amino functionalized silica nano-particle, then amine groups on the surface of the silica nano-particle bond to the thermoplastic resin providing a substantial increase in the amine density as shown in FIG. 5.

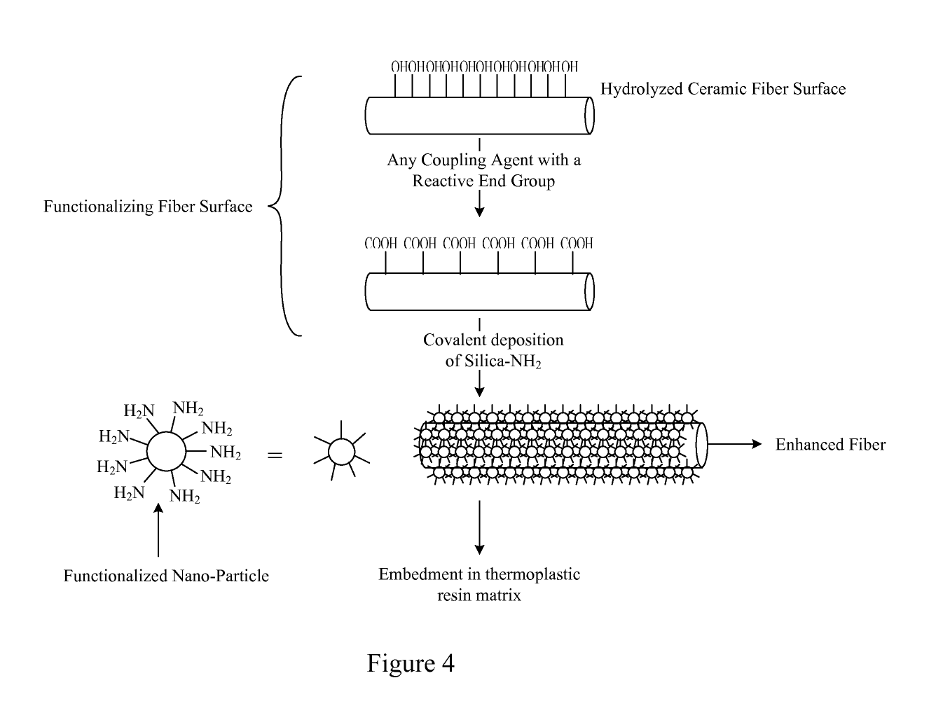

FIG. 4 graphically illustrates process 400 for functionalizing a ceramic fiber with nano-particles in accordance with the described embodiments. Functionalizing fiber surface sub-process 402 is graphically illustrated by ceramic fiber 404 having hydrolyzed ceramic fiber surface 406. Ceramic fiber 404 is then exposed to a coupling agent at 408 creating functionalized ceramic fiber surface 410. In the described embodiment, the functional groups used to functionalize ceramic fiber 404 take the form of hydroxyl groups. Next, the functionalized ceramic fiber is then exposed to functionalized nano-particles 412. In the described embodiment, the functionalized nano-particles 412 are formed of a silicate nano-particle 414 having a surface on which is bonded a plurality of amine groups (NH₂). Functionalized nano-particle 414 and functionalized ceramic fiber 404 are then combined causing a covalent deposition of the functionalized nano-particles 414 on functionalized ceramic fiber surface 410 to form the functionalized ceramic fiber 416 formed of ceramic fiber 404 having ceramic fiber surface 406 with a layer of functionalized silicate nano-particles 412 covalently bonded thereto. The functionalized ceramic fiber can then be used as an embedment in a thermoplastic resin matrix.

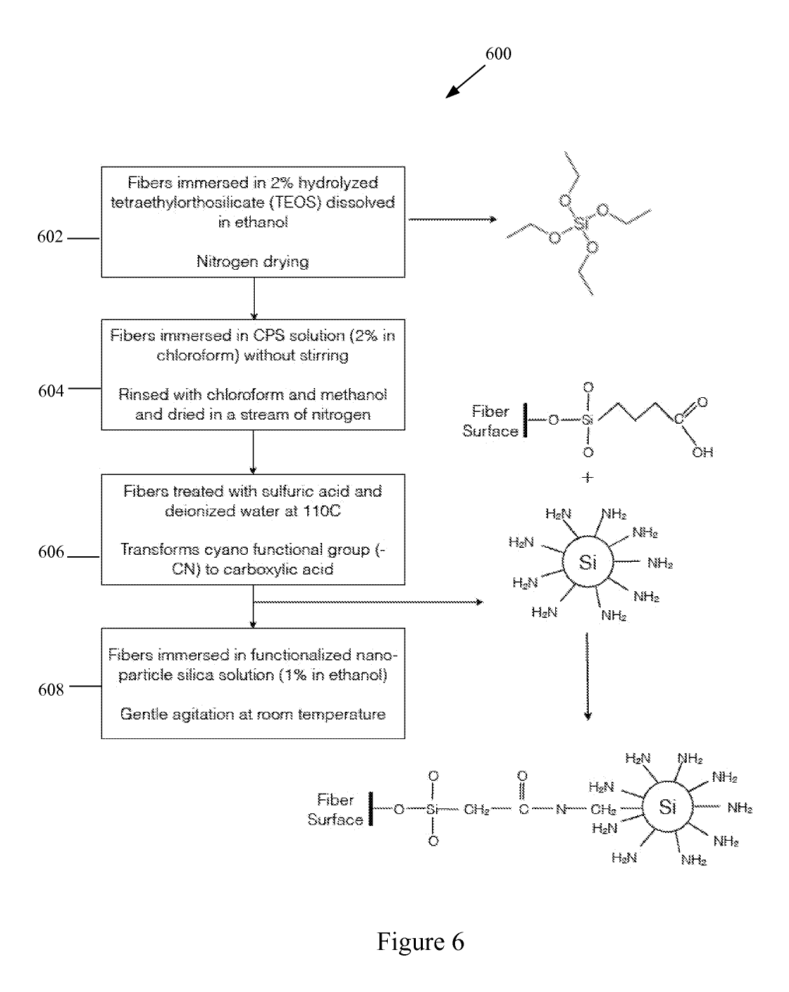

FIG. 6 shows a flowchart describing process 600 in accordance with the described embodiments. Process 600 can be carried out by performing at least the following operations. At 602, the ceramic fibers are immersed in hydrolyzed TEOS dissolved in ethanol. In one embodiment, this operation is followed by nitrogen drying. Next at 604, the fibers are immersed in CPS solution without stirring. In a particular implementation, the CPS solution is 2% in chloroform). Next at 606, the fibers are treated with sulfuric acid and de-ionized water at 110C. In this operation, a cyano functional group (—CN) is transformed into carboxylic acid. Next at 608, the fibers are then immersed in functionalized nano-particle silica solution and followed by gentle agitation at about room temperature.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. An injection moldable material comprising:
a thermoplastic material; and
a non-conductive ceramic fiber filler material wherein filaments of the ceramic fiber filler material comprises:
a ceramic fiber, and
a plurality of nano-particles bonded to a surface of the ceramic fiber, wherein most of the plurality of nano-particles are each associated with a plurality of reactive sites, the reactive sites being chemically and mechanically arranged to bond with the thermoplastic material.

2. The injection moldable material of claim 1, wherein the non-conductive ceramic fiber filler material is alumina.

3. The material of claim 1, wherein the thermoplastic material is selected from the group consisting of a polymer matrix, nylon, polycarbonate (PC), Polybutylene terephthalate (PBT), PBT/PC blends, Acrylonitrile Butadiene Styrene (ABS) and PC/ABS blends.

4. The injection moldable material of claim 1, wherein the nano-particles are silica nano-particles, and wherein each of the plurality of reactive sites is associated with an amino group.

5. The injection moldable material as recited in claim 1, wherein the ceramic fiber has a diameter of about 10 microns and a length of about 100 microns, wherein the nano-particles have diameters in the range of about 1 nm to about 2500 nm.

6. A method of forming an injection moldable material comprising:
providing a ceramic fiber;
functionalizing a surface of the ceramic fiber;
providing a plurality of functionalized nano-particles, wherein the functionalized nano-particles are each associated with more than one reactive site;
forming an enhanced filler by causing most of the plurality of functionalized nano-particles to bond the functionalized ceramic fiber surface; and
embedding the enhanced filler in a polymeric resin matrix.

7. The method as recited in claim 6, wherein the ceramic fiber is alumina and wherein the nano-particles are silicon.

8. The method as recited in claim 7, the functionalizing the surface of the ceramic fiber comprising:
hydrolyzing the ceramic fiber surface to add hydroxyl groups to the ceramic fiber surface; and
using a coupling agent to bond organic compound the hydroxyl groups.

9. The method as recited in claim 6, the functionalizing the surface of the ceramic fiber comprising:
immersing the ceramic fiber in tetraethylorthosilicate (TEOS) dissolved in ethanol;
nitrogen drying the ceramic fiber after immersion;
immersing the dried fibers in CPS solution without stirring;
rinsing with chloroform and methanol; and
drying in a stream of nitrogen.

10. The method as recited in claim 9, further comprising:
treating the ceramic fibers with sulfuric acid and deionized water at 110C;
immersing the fibers in funtionalized nano-particle silica solution; and
gently agitate the immersed fiber/solution.

11. A structural component for an electronic device, comprising:
a first metal component and a second metal component; and
an interface component between the first metal component and the second metal component that joins the first metal component and the second metal component together; wherein the interface component is formed from a composite material comprising:
a thermoplastic material,
a non-conductive ceramic fiber filler material wherein filaments of the ceramic fiber filler material comprises:
a ceramic fiber, and
a plurality of nano-particles bonded to a surface of the ceramic fiber, wherein most of the plurality of nano-particles are each associated with a plurality of reactive sites, the reactive sites being chemically and mechanically arranged to bond with the thermoplastic material.

12. The structural component of claim 11, wherein the thermoplastic material is nylon and the ceramic fiber filler material is alumina.

13. The structural component of claim 12, wherein the first metal component and the second metal component are formed from aluminum.

14. The structural component of claim 12, wherein the structural component is part of an external frame for the electronic device.

15. The structural component of claim 14, wherein the structural component is part of an internal frame for the electronic device.
